(19) United States
(12) Patent Application Publication
(10) Pub. No.: US 2024/0147900 A1
(43) Pub. Date: May 9, 2024

(54) MULTICROP HARVESTING HEAD

(71) Applicants: GENTLEFARMING SARL, Luxembourg (LU); G FAS SAS, CIUDAD AUTONOMA DE BUENOS AIRES (AR)

(72) Inventor: Ana FERNÁNDEZ MOUJÁN, San Fernando (AR)

(73) Assignees: BIOCERES GROUP PLC, Worthing, West Sussex (GB); G FAS SAS, CIUDAD AUTONOMA DE BUENOS AIRES (AR)

(21) Appl. No.: 18/552,816

(22) PCT Filed: Mar. 25, 2022
(86) PCT No.: PCT/EP2022/058032

§ 371 Date: Sep. 27, 2023

(30) Foreign Application Priority Data
Mar. 29, 2021 (AR) P20210100777

(51) Int. Cl. A01D 41/14; A01D 45/22; A01D 69/06

(52) U.S. Cl. CPC A01D 41/142; A01D 45/22; A01D 69/06

(57) ABSTRACT

The present invention relates to a multicrop header comprising a chassis (1), which comprises a kinematic chain (8) linked to a module selected from a cutter bar module (a) and a stripper module (b). This kinematic chain (8), powered by the harvester feeder, drives the rotor (f) embedded in the cutter bar module (a) or the command tire (7) embedded in the stripper module (b). The cutter bar (a) and stripper (b) modules are fixed to the sides of the chassis (1) using a single plurality of bolts (6) inserted in holes shared by both modules. The cutter bar module (a) includes a reel (c) mounted by a set of brackets (e) placed at the top of the chassis (1). The same set of brackets (e) attached to the chassis (1) allows the deflector (h) of the stripper module (b) to be mounted.

This invention consists in a multicrop harvesting head whose construction follows the guidelines described below and is illustrated in the figures enclosed for a better understanding of its development process. However, such description and figures must not be construed as a limitation to the invention, but as an aid for its study, understanding and application.

### PRIOR ART—PURPOSE

The main cereal and oilseed crops worldwide are harvested using mechanical equipment. The most widespread system today uses the so-called combined harvesters. Basically, they consist of two components: one of them detects the value of the crop and the other one separates the grain, delivers it clean to a warehouse, and returns material other than grain to the crop field as waste material that presents varying forms and degrees of processing.

The first component is referred to as “head” or “platform”, and we can observe that heads are divided into three main groups, depending on the type of crop they are intended to. Thus, we can find harvesting heads for small grains, for corn/sunflower, and for sunflower.

These groups have been developed considering the distinctive characteristics of the plant structure. In general, the aim is that the lowest amount of material other than grain enters the threshing unit, so as to reduce energy consumption and equipment wear.

For example, in the case of corn—clearly the cereal that concentrates the highest production volume globally—the grains to be harvested are in the corn ears, which are found in the center of the plant. Pulling-out systems have been developed for harvesting. These systems became widespread to such an extent that there is a huge number of manufacturers that supply different versions of the same spike pulling-out machine.

In the case of wheat, barley and rice (“small grains”)—which follow corn as regards cultivated land area—, spikes and panicles are on the top of the plant, so the plant stalk is cut below that height using cutting heads.

These cutting heads are efficient in terms of harvesting work, but the cutting process produces too much material that must be disposed of in the threshing unit.

In American countries, soybean covers the largest cultivated land area, and although the crop structure is different, the same harvesting head used for wheat and other cereals is employed. The most usual adaptation is a flexible cutter bar system mounted on the harvesting head that adjusts to ground undulations. Since soybean has pods containing seeds from the bottom of and along the stem, this flexible cutter bar is necessary to cut the plants below the lower pods height. This led to the use of wheat-soybean harvesting heads that have become widespread and have allowed the use of the same head for both crops, holding the cutter bar in a firm position when wheat or other cereals of similar structure are harvested. In this case, the device operates at a such a height that ensures that cutting can be done below the spikes level, without the need of copying ground irregularities. When the head is used for harvesting soybean, the cutter bar is placed on skids that copy the ground.

These wheat-soybean harvesting heads include a sprocket reel that helps to carry the cut material towards the conveying unit of the head, which may consist in a tarpaulin system known as “draper” or at least a crawler.

The introduction of the stripper system has allowed grains to be extracted from spikes and panicles directly, without having to cut the plant. This has meant a big change in the harvesting process of cereals such as wheat, rice, barley and others. This system considerably reduces the amount of material other than grains (MOG).

The main limitation of the stripper system is that it is not adaptable to soybean harvesting. This is why its use has not been widespread, despite the great advantages it offers for wheat, rice, barley and other crops.

Producers and contractors can amortize their equipment better by not having to purchase an additional head, which is more efficient but forces them to duplicate investment. Equipment size is becoming increasingly bigger and obviously require higher capital investment but, considering its low annual utilization rate, the amortization period is extended and fixed costs increase, reaching values that cannot be absorbed.

If a harvester's owner provides services to third parties, the annual utilization rate increases, thus decreasing fixed costs and allowing the same equipment to be used at the end of Winter and beginning of Spring for harvesting wheat, barley and rape, among others; or at the end of Summer and beginning of Autumn for harvesting crops such as soybean.

The invention proposed herein, which is the object of the present invention patent, consists in a multicrop harvesting head that can be used for harvesting work that requires a fixed or flexible cutting system, as well as for those in which a stripper system can be used.

A main object of the invention disclosed herein is to keep the critical components of a harvesting head, such as the chassis and the kinematic chain for conveying material up to the discharge pipe.

Another object of the invention herein is to facilitate and speed up parts replacement, so that the stripper system and the cutter bar system can be exchanged when the efficiency of the harvesting process is enhanced by using either of them.

Implicit both in the description above and in the explanation of the equipment operation that is provided below is that the invention proposes the use of an single adaptable head, so that a stripper system or a fixed or flexible cutter bar system can be mounted just by replacing components.

### BRIEF DESCRIPTION OF THE INVENTION

As said above, the invention described herein consists in a multicrop harvesting head that comprises a chassis, which includes a conveying unit, a single kinematic chain and hooking fittings that can be attached to the harvesting machine.

Alternatively, a cutter bar module and a stripper module can be attached to the chassis.

The cutter bar module comprises a blade gearbox attached to a flexible cutter bar, supplemented by a copying system and a reel.

On the other hand, the stripper module includes a command tire that drives a rotor equipped with stripping combs, a deflector and a cover.

The chassis is a universal type part, that is, it allows attaching both modules using a plurality of bolts placed in corresponding holes that are arranged in the same position and allow the modules to be attached to the chassis.

### FIGURES

Schematic figures that provide a better understanding of the subject matter disclosed herein are enclosed herein.

Such figures have been schematized at variable scales, FIG. 1 showing a partial perspective view where the kinematic chain, tire, gearbox and copying system can be observed.

FIG. 2 shows a partial perspective view where the chassis, stripper module, reel and a bracket can be observed.

FIG. 3 shows a partial perspective view where the cutter bar module, rotor, stripping combs and conveying unit can be observed.

FIG. 4 shows a partial perspective view where the blades and bolts can be observed.

FIG. 5 shows a partial perspective view where the flexible cutter bar and blades can be observed.

FIG. 6 shows a partial perspective view where the deflector, cover and a hooking fitting can be observed.

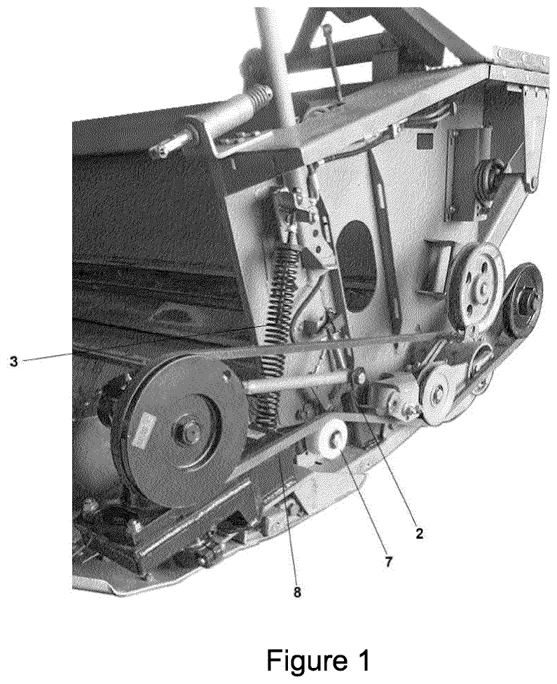

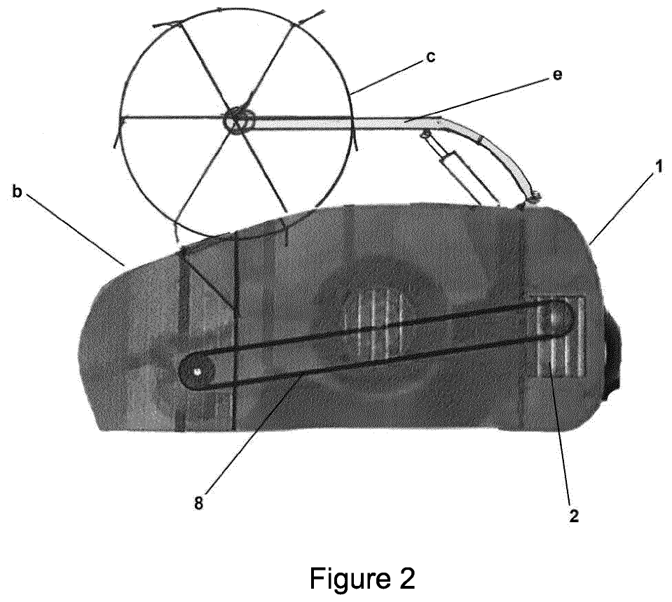

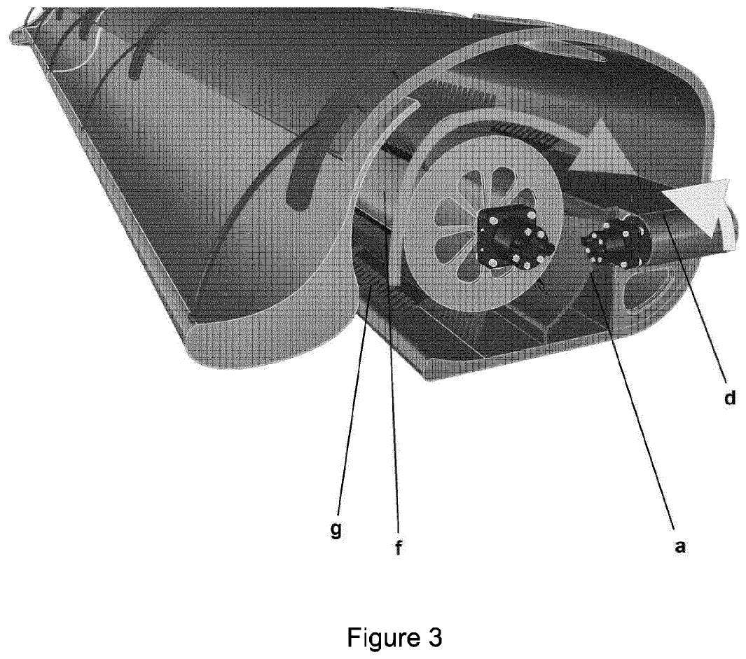

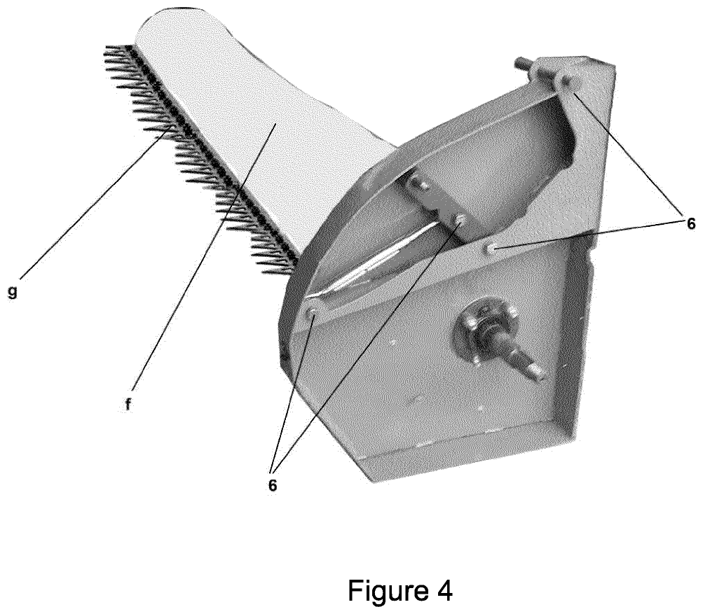

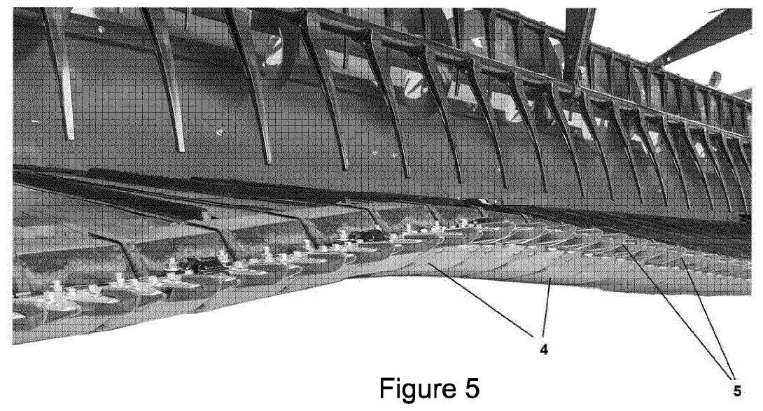

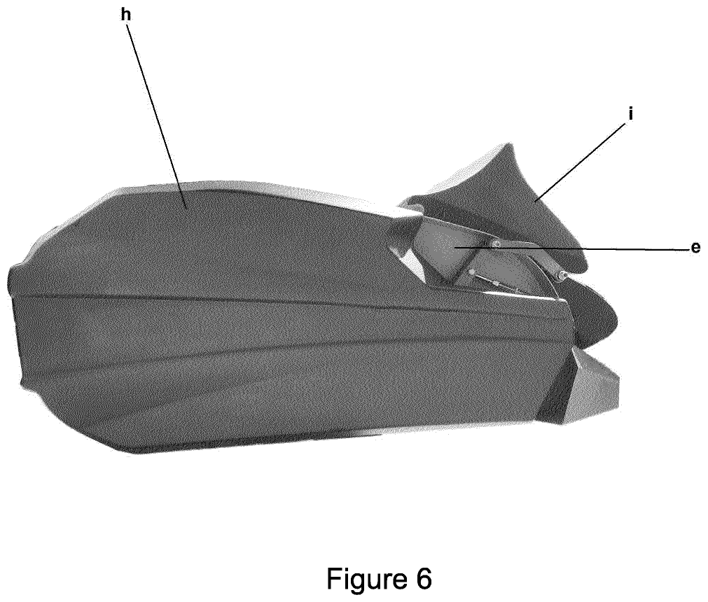

### REFERENCES

In the figures shown, the same characters represent equivalent or supplementary parts.

It must be noted that, in the following description, reference numbers are placed between hyphens when they are first used and between parentheses when they appear later in the text. This makes it easier to follow the description, as all references between hyphens designate a part that has not been previously described.

Thus, reference -1- designates a chassis, reference -2- designates a gearbox, reference -3- designates a copying system, reference -4- designates a cutter bar, reference -5- designates blades, reference -6- designates a bolt, reference -7-designates a command tire, and reference -8- designates a kinematic chain.

Letter -a- designates a cutter bar module, letter -b- designates a stripper module, letter -c- designates a reel, letter -d- designates a conveying unit, letter -e-designates a bracket, letter -f- designates a rotor, letter -g- designates a stripping comb, letter -h- designates a deflector, and letter -i- designates a cover.

### Operation

In order to develop a multicrop harvesting head, the inventors have deemed it necessary to have a harvesting head that allows combining, on the one hand, the high efficiency level provided by a stripper system for crops such as wheat, barley, rice and those that share the common feature of presenting spikes or panicles at the top of the stalk, enabling the system to thresh them without the need of cutting the stalks; and, on the other hand, the potential of a usually flexible cutter bar system that copies ground irregularities while reaping the stalks with pods containing grains, in crops such as soybean and the like.

As it is intended for spikes, when the stripper is used for harvesting pods, those at the lower part of the stalks are wasted and this system becomes inefficient.

Therefore, a flexible cutter bar system is more appropriate, as it copies the ground and cuts the stalk from its bottom section, also pulling out the lower pods.

It is extremely difficult to adapt the stripper system for copying the ground and the stripping rotor to cut the stalks from their bases.

The inventor knows that the prior art platform allows for interchangeable heads, so that the same machine can be used with one head as a stripper system and with another head as a cutter bar system.

Based on this possibility of head exchange, the inventor has sought to address the difficulties associated to parts exchange.

To do so, a single harvesting head (and therefore a single chassis -1-) is used for all crops, to which a cutter bar module -a- applicable to, for example, soybean harvesting or a stripper module -b- applicable to, for example, wheat harvesting can be attached interchangeably.

As anticipated, both for the harvesting of soybean and those grains contained in pods distributed along the stalks in such a way that they can reach the ground surface, the cutter bar module (a) equipped with a gearbox -2- that allows an alternative movement is used, as well as a copying system -3- that fits the flexible cutter bar -4-, allowing it to copy ground irregularities and adapt to them so as to facilitate blade -5- operation.

As usual, el cutter bar module (a) is supplemented by a reel -c- that carries the cut material towards a conveying unit -d-, which may consist of belts, tarpaulins or crawlers that convey the material towards the harvesting machine.

When the plant characteristics change, as in the case of wheat, barley, rice and the like, the cutter bar module (a) is removed and replaced with the stripper module (b). To do so, the cutter bar module (a), including the gearbox (2) and copying system (3), is disassembled by removing a plurality of bolts -6- that fix the cutter bar module (a) to the chassis (1).

Upon removing the cutter bar module (a), the reel (c)—which is mounted by a set of brackets -e- placed at the top of the chassis (1)—must also be removed.

The removal of said set of brackets (e), as well as the reel (c), is a usual procedure for conventional harvesting heads during maintenance activities. This task does not require any specific tools or knowledge.

Once removal is completed, the parts necessary for the equipment to operate as a stripper system can be installed in the chassis (1). The stripper module (b) includes a command tire -7- powered by the harvester feeder through a kinematic chain -8-, just like the different components of the cutter bar module (a).

The stripper module (b) is supplemented by a rotor -f- that comprises stripping combs -g-, a deflector -h- fixed to the top section of the rotor (f) and along the platform, and a cover -i-.

Once the stripper module (b) has been attached to the chassis (1), the deflector (h) must be assembled using the same bracket system (e) that supported the reel (c) in the cutter bar module (a).

Such brackets (e) allow forward, backward, upward and downward movements.

In the preferred embodiment, such movements are driven by the machine hydraulic system, but electrical or manual options are not excluded.

Once the reel (c) and deflector (h) are assembled, the cover (i) must be placed to prevent grains from going out as a result of turbulence and bouncing off the bottom section of the chassis (1). Using a plurality of hooking fittings -j-, the cover (i) is attached to the deflector (h).

The cutter bar (a) and stripper (b) modules are fixed to the sides of the chassis (1) using the same plurality of bolts (6) placed in holes shared by both modules.

They also share the kinematic chain (8) that drives the rotors (f) and is powered by the harvester feeder.

As soybean covers the largest cultivated area in our country, cutter bar systems (4) are mostly used, since, as said, they are focused on harvesting plants with pods over the whole stalk length. This is why, in many cases, the cutter bar system (4) is also used for harvesting wheat, barley and the like.

The invention disclosed herein allows to avoid the duplication of platforms, since it is enough to have a platform that comprises a single harvesting head and a kit for replacing the cutter bar module (b) with a stripper module, and vice versa.

Thus, a preferred form for using the invention, which supports non limiting alternatives, has been described and illustrated herein.

1. A multicrop harvesting head of such a type that comprises a chassis attachable to a cutter bar or a stripper; of the type in which the cutter bar can be linked to a gearbox that triggers an alternating movement, a copying system, a reel that leads the cut material towards a conveying unit, which in turn carries such material to the harvesting machine; of the type in which the stripper includes a command tire supplemented by a rotor, stripping combs, a deflector and a cover; characterized in that, at each end, the chassis provides a kinematic chain that can be linked to a module selected from a cutter bar module and a stripper module and that drives both the rotor embedded in such cutter bar module and the command tire embedded in such stripper module, such kinematic chain being powered by the harvester feeder; whose cutter bar and stripper modules are fixed to the sides of the chassis using the same plurality of bolts inserted in holes shared by both modules; whose cutter bar module includes a reel mounted through a set of brackets placed at the top of the chassis; whose set of brackets fixed to the chassis holds the deflector of the stripper module in place; and where the brackets, fed by the machine hydraulic system, can make forward, backward, upward and downward movements.

2. The harvesting head according to claim 1, characterized in that the cutter bar module (a) is linked to a flexible cutter bar that copies uneven ground and puts blades into position, facing plant stalks.

3. The harvesting head according to claim 1, characterized in that the stripper module comprises a rotor including stripping combs and a deflector attached to the upper part of the rotor and along the platform, and a cover.

4. The harvesting head according to claim 1, characterized in that a plurality of hooking fittings and a cover are mounted on the deflector.

5. The harvesting head according to claim 1, characterized in that the movement of the brackets is electrically driven.

6. The harvesting head according to claim 1, characterized in that the movement of the brackets is manually driven.
